(19) United States
(12) Patent Application Publication
(10) Pub. No.: US 2004/0003255 A1
(43) Pub. Date: Jan. 1, 2004

(54) Secure email time stamping

(75) Inventors: Axelle Apvrille, Toulouse (FR); Robert Klunker, Le Gaillardou (FR)

Correspondence Address: Wayne P. Bailey, Storage Technology Corporation, One Storage Tek Drive, Louisville, CO, 80028-4309, US

(73) Assignee: Storage Technology Corporation

(21) Appl. No.: 10/184,477

(22) Filed: Jun. 28, 2002

(51) Int. Cl. H04L 9/00

(52) U.S. Cl. 713/178

(57) ABSTRACT

A server includes a dedicated hardware card that is responsible for digesting an incoming email, appending a date and time to the digest to create a time stamp, and signing the result with a private digital signature. This provides a secure time stamp for an email that is resistant to falsification and tampering by the sender of an email, and which can be verified by a recipient of the email.

### BACKGROUND OF THE INVENTION

1. Field of the Invention:

This invention relates generally to electronic mail, and more particularly to secure time stamping of electronic mail.

2. Background of the Invention:

In the past years email has become a common form of communication. Email is used extensively in business and private sectors for daily communication.

When a user sends an email, the local email sender program retrieves the internal clock of the sender's machine and adds the current date and time to the message. The email is then sent, and each SMTP (Simple Mail Transport Protocol) server that receives or relays the message adds a time stamp to the SMTP message.

SMTP is the primary protocol for transferring e-mail across the Internet. SMTP servers serve as an intermediary e-mail service for processing and forwarding mail across the net.

The dates and times added to an email message by the sending program are not reliable and can be altered or inaccurate. For example, a user may set the internal clock of the sending computer and consequently modify the date of the email. More importantly, most SMTP servers accept the “Date” command from senders, which allows users to specify any date on an email.

Furthermore, mail servers' clocks themselves may be incorrectly synchronized. Consequently, time stamps they append to the SMTP message (the “received” parameter) cannot provide any useful indication to trace down the message. For instance, if a mail server A relays mail to server B and their clocks are poorly synchronized, the time stamp of server B may indicate a date before that of server A, even though the message arrived at B later than at A.

Multiple products propose mail signing, such as PGP and others. In such schemes, once signed, an email's date cannot be modified undetectably. However, such schemes only provide data integrity, but not time integrity. That is, they do not guarantee that the initial date is correct, nor that relaying SMTP servers append a correct and unaltered time stamp.

### SUMMARY OF THE INVENTION

The present innovations provide a secure time stamping of emails with the date received by an SMTP server. In a preferred embodiment, the innovative server includes a dedicated cryptographic hardware time stamping card that creates a digest of incoming SMTP messages, appends the date and time to the digest, inserts part or all of the digest (preferably at least the date and time) to the body of the email (referred to as “time stamping” the email), and finally adds a digital signature with the time stamping card's private key. In such an embodiment, recipients with the public key of the card can verify the digital signature, and hence the time stamp. Other embodiments accomplish time stamping of emails from a cryptographic hardware in other ways, as described below.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows an example of how to send an email with a falsified date using commands accepted by an SMTP server

FIG. 2 shows the resulting email as seen by the recipient.

FIG. 3 shows how an innovative secure time stamped email appears.

FIG. 4 shows a chart of process steps for a preferred embodiment.

FIG. 5 shows a network for use with a preferred embodiment.

FIG. 6 shows a data processing system that may be implemented as a server for use with a preferred embodiment.

### DETAILED DESCRIPTION OF THE PREFERRED EMBODIMENT

The present innovations teach a solution based on an innovative Time Stamping SMTP server. Such a server preferably provides normal SMTP services, and has an additional time stamper dedicated hardware card. Preferably, this card is tamper resistant, and is responsible for: digesting the whole SMTP message it receives; appending date and time to the digest (an internal clock on-board the innovative dedicated hardware card preferably provides a reliable date) to create a time stamp; and signing the resulting time stamp with the card's private key. It is important to note that we assume this clock is trusted. It is preferably periodically synchronized from an external source. The hardware card is preferably inaccessible by senders of an email and tamper resistant to such senders. The card need not necessarily be entirely tamper resistant, but preferably at least provides notice if any tampering has occurred.

In a preferred embodiment, when the Time Stamping SMPT server receives an email, it retrieves the whole SMTP message and creates a digest, then asks the secure time stamp hardware card to process an accurate time for the message. The innovative process preferably digests at least the sender, subject, date, content, and recipient fields of the email message. At a maximum, the entire SMTP message can be digested as it is received, including all fields.

The time stamp is then signed with the private key. The time stamp is appended to the email, preferably added to the body of the email so that a recipient can access it. This is the reliable date that can be trusted for the email. The digital key will allow a user to discover any tampering or other integrity errors related to the date of the email. Note that the digest and/or time stamp can also be attached to the email as an attachment, or otherwise made accessible to the recipient of the email. (For example, a link to the time stamp could be added to the email.) In such an embodiment, the receiving computer needs the public keys of all the time stamping SMTP servers the email has gone through. Those public keys can be automatically joined to the signature in a public key certificate. The recipient can receive the public key directly from the SMTP server, or from a web page, or included in the email. More precisely, the SMTP server preferably sends a public key and a certificate, and the client is able to download the keys and certificates into a personal directory. To verify an email's time stamp, the user retrieves the correct keys and certificate from that directory.

Of course, multiple techniques exist to store and access public keys and certificates. The examples listed are only meant to serve as examples consistent with the present innovations

The present system preferably distinguishes between three different dates. The date sent by the sender is not acted upon, unless the sender's machine itself includes the trusted innovative time stamp hardware card. The SMTP servers also stamp dates in the received parameter of the email. These dates are also preferably not modified by the present innovations. In a less preferred embodiment, the trusted time stamp's date is placed here, which requires modification of the code in the SMTP server. Preferred embodiments do not modify this date and therefore do not modify the SMTP server's implementation.

Finally, the trusted innovative time stamping hardware card includes a date in the time stamp that is appended to the content of the email (or in an attachment, or with a link, for example, as described herein). This date is a reliable date.

The present system does not actually prevent a sender or relaying SMTP server from setting a bad date in the email. However, when reading the email, the recipients know that those dates are unreliable and they can ignore them in favor of the reliable time stamped date from the Time Stamping SMTP server.

FIG. 1 shows an example of how to send an email with a falsified date using commands accepted by an SMTP server (such as MAIL FROM:, RCTP TO:; DATA etc.). This figure shows how to configure the email server to show a false date. The top line shows an SMTP server banner 102 displayed when the mailer program is launched. The date shows Friday Apr. 12, 2002. On the ninth line, the date 104 set by the sender of the email appears as Oct. 23, 1998.

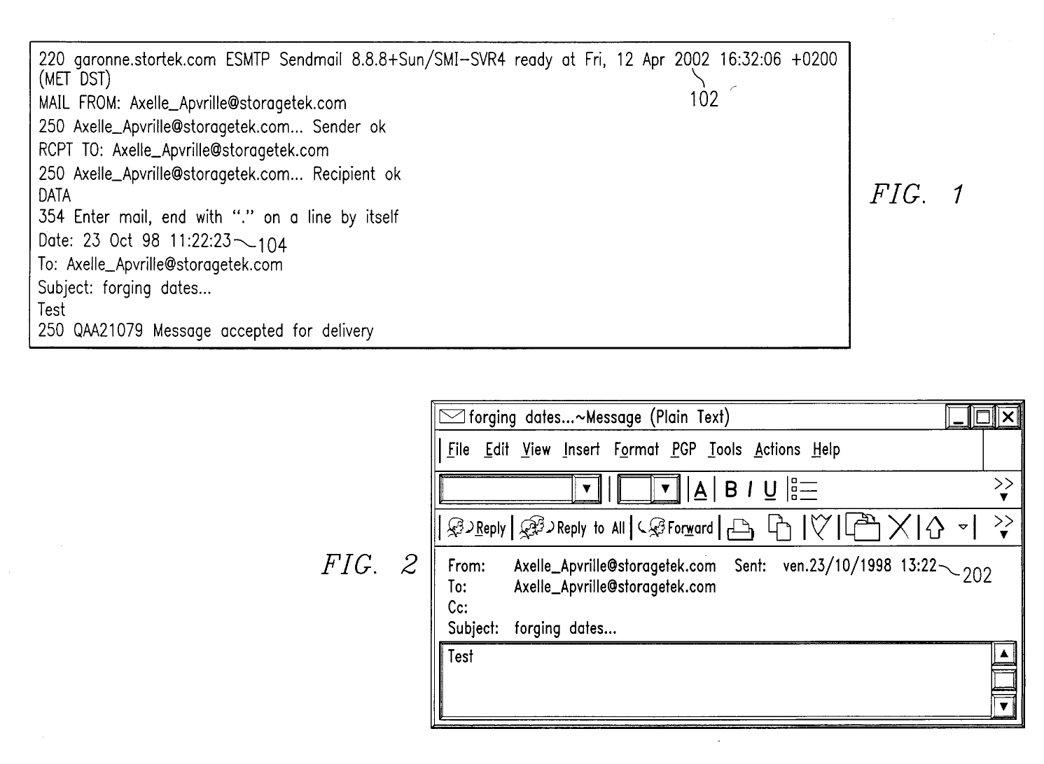

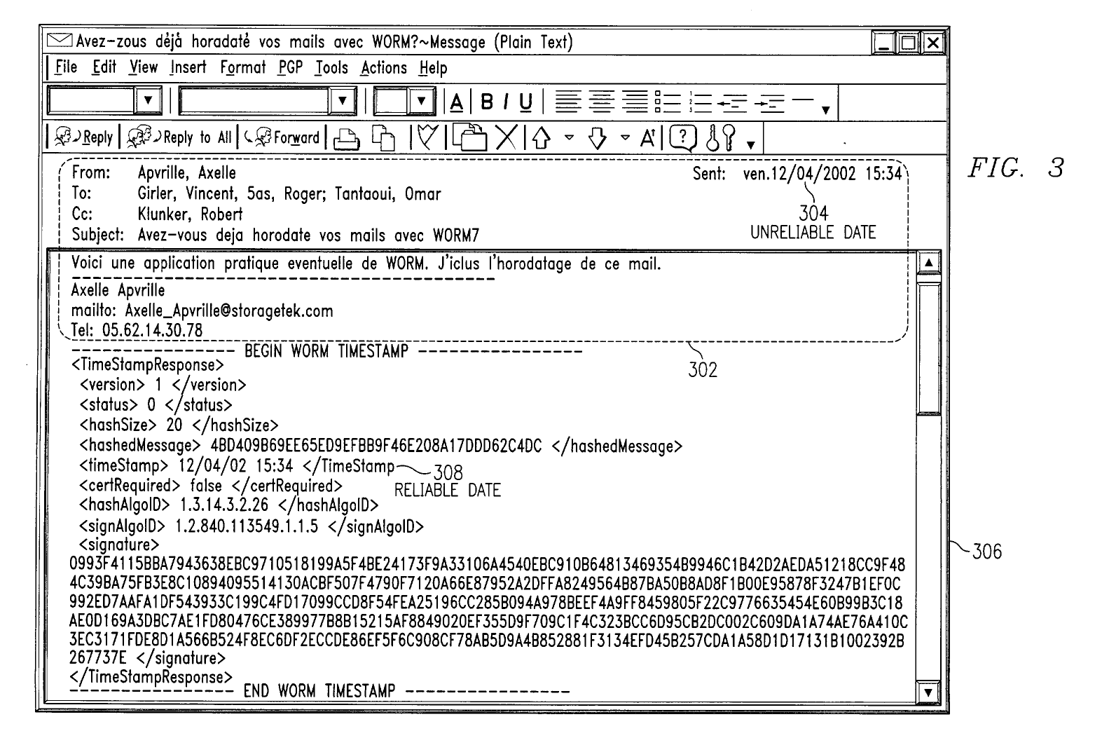

FIG. 2 shows the resulting email as seen by the recipient. The date 202 shown is Oct. 23, 1998. Note that there is no obvious indication that this date is false, as no other time stamp or time indication appears in the body of the email message. Hence, a recipient would not be alerted to the fact that the date is incorrect.

FIG. 3 shows how an innovative secure time stamped email appears. The top text in the body of the email (within the box 302) comprises the message itself. Note that the date 304 appearing in the upper right hand corner of the box 302 is the date added by the sender's email program, and is not reliable. This date 304 can be falsified as shown above, and a recipient of the email has no indication of whether this date is accurate or not.

Beneath the box 302 is the time stamp 306, labeled a “Worm Timestamp” in this example. Within box 308 there appears a second date, which the sender of the email has no access to. This date is appended to the body of the email (where a recipient can read it) by an innovative Time Stamping SMTP server, which is equipped with the innovative dedicated time stamping card, a hardware addition to the traditional SMTP server.

In this example, the time stamp 306 is shown in XML format. Many programs exist which can parse and process XML. Of course, the time stamp can be appended in any number of formats, either requiring further processing or being viewable by a recipient without such further processing.

In a preferred embodiment, a recipient of the time stamped email must use the public key to verify that the time stamp has not been altered and that data integrity of the stamp has been retained. This is done in a preferred embodiment by sending the public key of the time stamping server's along with the email to the intended recipient of the email. Preferably the public key is accompanied by a certificate authenticating the source of the key. Alternatively, the public key (and any needed certificates) can be obtained from elsewhere, such as a repository of such keys on the internet, for example. In such a case, the key can also be used to verify the authenticity of the message, i.e., that it came from the claimed source

This verification of the integrity and/or authenticity of the time stamp can be accomplished in a number of ways. For example, in one embodiment, the user launches a “verify time stamp” application which checks the relevant keys to make sure the time stamp hasn't been tampered with. Such a program could be separate, or integrated into the recipient's email program, so that a button to “verify time stamp” can be pressed which will automatically verify the time stamp. In another, more preferred embodiment, a program automatically verifies the incoming email time stamp without the user taking any action. If the time stamp has been altered or the keys do not otherwise match, a warning is preferably presented to the user indicating the problem.

Likewise, the process can also be invoked from the sender's end as well. A sender's email program is programmed to include invoking a time stamping function from the Time Stamping SMTP servers that it passes through, or causing the email message to be routed to a specific Time Stamping SMTP server. In this embodiment, the recipient of the email would see an indication within the email that the secure time stamping function has been used, and will know to check the time stamp's key for integrity.

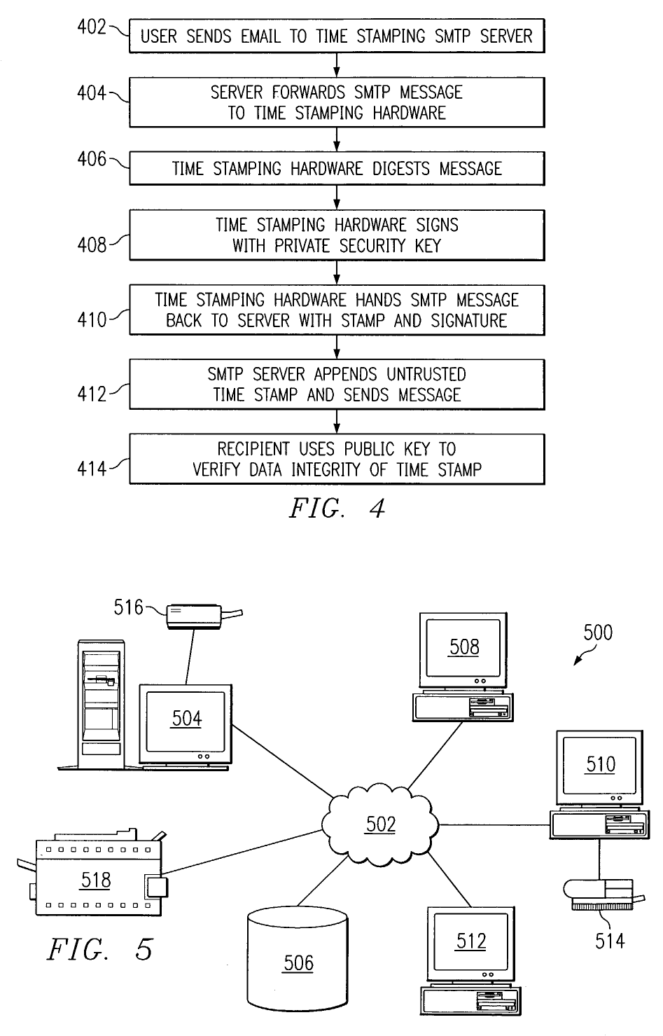

FIG. 4 shows a chart of process steps for a preferred embodiment. It should be noted that this is only one example of many potential implementations.

First, a user prepares an email using a typical email program which arrives at an innovative Time Stamping SMTP server (step 402). The server then retrieves the email and forwards it to the time stamping hardware (step 404). The time stamping hardware digests the message (step 406). The time stamping hardware then builds a trusted time stamp and signs the resulting time stamp digitally with a private security key (step 408). The stamping hardware then hands the mail back to the server, with the message now including the initial message with the time stamp and signature (optionally the public key and certificate) (step 410) so that the recipient can verify the integrity of the information. The SMTP server then appends its own untrusted time stamp, and sends the message (step 412). The recipient receives the email and uses the public key (either automatically or by invoking such a function) to verify data integrity of the time stamp (step 414). If the key works, the recipient of the email can trust the date of the time stamp as being accurate and not tampered with by the sender.

FIG. 5 depicts a pictorial representation of a network of data processing systems in which the present invention may be implemented. Network data processing system 500 is a network of computers in which the present invention may be implemented. Network data processing system 500 contains a network 502, which is the medium used to provide communications links between various devices and computers connected together within network data processing system 500. Network 502 may include connections, such as wire, wireless communication links, or fiber optic cables.

In the depicted example, a server 504 is connected to network 502 along with storage unit 506. In addition, clients 508, 510, and 512 also are connected to network 502. These clients 508, 510, and 512 may be, for example, personal computers or network computers. In the depicted example, server 504 provides data, such as boot files, operating system images, and applications to clients 508-512. Clients 508, 510, and 512 are clients to server 504. Network data processing system 500 includes printers 514, 516, and 518, and may also include additional servers, clients, and other devices not shown.

In the depicted example, network data processing system 500 is the Internet with network 502 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 500 also may be implemented as a number of different types of networks, such as for example, an intranet, a local area network (LAN), or a wide area network (WAN). FIG. 5 is intended as an example, and not as an architectural limitation for the present invention.

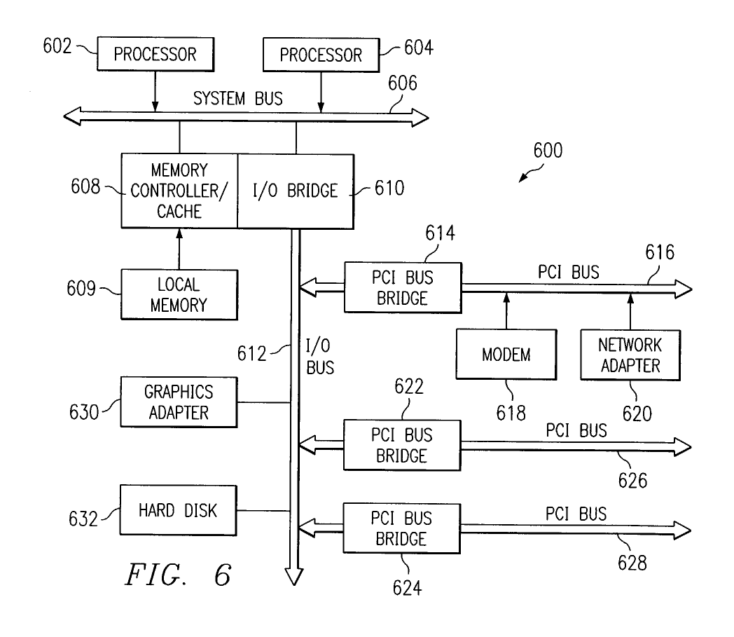

Referring to FIG. 6, a block diagram of a data processing system that may be implemented as a server, such as server 504 in FIG. 5, is depicted in accordance with a preferred embodiment of the present invention. Data processing system 600 may be a symmetric multiprocessor (SMP) system including a plurality of processors 602 and 604 connected to system bus 606. Alternatively, a single processor system may be employed. Also connected to system bus 606 is memory controller/cache 608, which provides an interface to local memory 609. I/O bus bridge 610 is connected to system bus 206 and provides an interface to I/O bus 612. Memory controller/cache 608 and I/O bus bridge 610 may be integrated as depicted.

Peripheral component interconnect (PCI) bus bridge 614 connected to I/O bus 612 provides an interface to PCI local bus 616. A number of modems may be connected to PCI bus 616. Typical PCI bus implementations will support four PCI expansion slots or add-in connectors. Communications links to network computers 608-612 in FIG. 5 may be provided through modem 618 and network adapter 620 connected to PCI local bus 616 through add-in boards.

Additional PCI bus bridges 622 and 624 provide interfaces for additional PCI buses 626 and 628, from which additional modems or network adapters may be supported. In this manner, data processing system 600 allows connections to multiple network computers. A memory-mapped graphics adapter 630 and hard disk 632 may also be connected to I/O bus 612 as depicted, either directly or indirectly.

Those of ordinary skill in the art will appreciate that the hardware depicted in FIG. 6 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 6 may be, for example, an eServer pSeries system, a product of International Business Machines Corporation in Armonk, N.Y., running the Advanced Interactive Executive (AIX) or Linux operating systems.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A server, comprising:
means for providing email transfer;
time stamping hardware;
wherein the time stamping hardware adds a time stamp to an email message, and adds a digital signature to the time stamp.

2. The server of claim 1, wherein the time stamp is appended to the body of the email message.

3. The server of claim 1, wherein email is transferred using simple mail transfer protocol.

4. The server of claim 1, wherein the time stamp includes a public key certificate.

5. The server of claim 4, wherein the public key is used to verify integrity of the time stamp by a time stamp verification application.

6. The server of claim 1, wherein the time stamping hardware updates a time and date via an external source.

7. The server of claim 1, wherein a sending email program requests that the time stamp be added to the email message.

8. A computer system, comprising:
a server;
time stamping hardware;
wherein the time stamping hardware digests an incoming mail message, adds a time stamp to the incoming mail message, and signs the time stamp with an encrypted key.

9. The system of claim 8, wherein the time stamp comprises a digest of the incoming mail message and the date and time the incoming mail message was received.

10. A method of providing secure time stamping to emails, comprising the steps of:
digesting at least part of a received email message;
adding a date and time to the email message;
adding a digital signature to the message.

11. The method of claim 10, wherein the date and time are obtained from an internal clock.

12. The method of claim 11, wherein the internal clock is updated from an external source.

13. The method of claim 10, wherein the digital signature is appended to a digest, wherein the digest comprises information associated with the incoming email message and the date and time.

14. The method of claim 13, wherein the digest is appended to the email message.

15. A method of providing secure email time stamping, comprising the step of:
adding a time stamp to an incoming email using cryptographic hardware residing in a server.

16. The method of claim 15, wherein the time stamp includes a digest of the incoming email, date, time, and a digital signature.

17. The method of claim 16, wherein the time stamp is verified by a public key to the digital signature.

18. The method of claim 15, wherein the time stamp is appended to the body of the email.

19. The method of claim 15, wherein the time stamp is added by dedicated hardware residing on the server.

20. The method of claim 15, wherein the server is an SMTP server.

21. A computer system, comprising:
an email program capable of receiving an incoming email and displaying the email to a user;
wherein when the email program receives an email with a time stamp signed with a digital signature, digital signature is verified.

22. The system of claim 21, wherein the email with the time stamp includes a public key to the digital signature.

23. The system of claim 21, wherein the email program acquires a public key to the digital signature from a remote location.

24. The system of claim 21, wherein the email program verifies the digital signature without user intervention.
